(19) United States
(12) Patent Application Publication
(10) Pub. No.: US 2010/0164722 A1
(43) Pub. Date: Jul. 1, 2010

(54) THEFT DETERRENCE TECHNOLOGY USING ASYNCHRONOUS NOTIFICATION

(76) Inventors: Duncan Glendinning, Chandler, AZ (US); Vijay Rao, Beaverton, OR (US)

Correspondence Address: INTEL CORPORATION;c/o CPA Global, P.O. BOX 52050, MINNEAPOLIS, MN, 55402, US

(21) Appl. No.: 12/347,996

(22) Filed: Dec. 31, 2008

(51) Int. Cl. G08B 13/14

(52) U.S. Cl. 340/568.1

(57) ABSTRACT

For one disclosed embodiment, an enabled state of a mobile computing platform may be modified in response to an asynchronous notification from a server. Other embodiments are also disclosed.

### FIELD

Embodiments described herein relate to the field of data and asset protection. More particularly, at least one embodiment relates to expediting activation of theft deterrence remediation services upon determining that a mobile computing platform has been stolen.

### BACKGROUND

Mobile computing platforms are expensive and thus may be an attractive target for cash-strapped thieves. Mobile computing platforms may also store sensitive information and thus may be an attractive target for another class of thieves. Thus, computing platforms equipped with theft deterrence technology (TDT) will periodically, in a policy-defined time period, communicate with a server which controls TDT behavior to determine the status of the computing platform (e.g., stolen/not stolen). Conventionally, the server would reset an internal timer in the mobile computer as long as the mobile computer contacts the server in the policy-defined time period and the mobile computer is in a safe state.

### BRIEF DESCRIPTION OF THE DRAWINGS

Embodiments are illustrated by way of example and not limitation in the figures of the accompanying drawings, in which like references indicate similar elements and in which:

FIG. 1 illustrates, for one embodiment, an apparatus to protect a mobile computing platform (MCP);

FIG. 2 illustrates, for one embodiment, a method associated with asynchronous notification of MCP loss;

FIG. 3 illustrates, for one embodiment, a method associated with asynchronous notification of MCP loss; and

FIG. 4 illustrates, for one embodiment, a system where a theft deterrence technology in a mobile computing platform may communicate with server(s) and vice versa.

The figures of the drawings are not necessarily drawn to scale.

### DETAILED DESCRIPTION

The following detailed description sets forth example embodiments of apparatuses, methods, and systems relating to theft deterrence technology asynchronous notification. Features, such as structure(s), function(s), and/or characteristic(s) for example, are described with reference to one embodiment as a matter of convenience; various embodiments may be implemented with any suitable one or more described features.

For one embodiment, asynchronous notification may be used with theft deterrence technology (TDT) to allow a server to directly contact a mobile computing platform (MCP) to change the state of the MCP rather than waiting for the MCP to rendezvous with the server based on a previously provisioned rendezvous timer contained within the TDT mechanism of the MCP itself.

One embodiment may utilize hardware and cryptographic capabilities of an integrated embedded controller (IEC) in a MCP to protect data on the MCP and/or the MCP itself using an asynchronous or push possession notification protocol originating from the server. This asynchronous notification for one embodiment may augment the TDT capability disclosed in U.S. patent application Ser. No. 11/824,432, filed Jun. 29, 2007, and entitled COMPUTER THEFT DETERRENCE TECHNOLOGY, and in U.S. patent application Ser. No. 12/152,562, filed May 15, 2008, and entitled DISABLING ENCRYPTED DATA.

For one embodiment, the push notification may be used to expedite activation of MCP theft deterrence remediation services by having a server attempt to directly contact an affected MCP rather than waiting for the affected MCP to eventually contact the server upon expiration of a rendezvous timer. For one embodiment, theft deterrence logic and secured storage in a MCP may be implemented in firmware in an IEC. This may make the MCP less susceptible to operating system and/or hard drive replacement strategies employed by thieves. The IEC for one embodiment may be a member of a chipset for the MCP.

“Logic”, as used herein, includes but is not limited to hardware, firmware, software in execution, and/or combinations thereof to perform a function(s) or an action(s), and/or to cause a function or action from another logic, method, and/or system. Logic may include a software controlled microprocessor, discrete logic (e.g., application specific integrated circuit (ASIC)), an analog circuit, a digital circuit, a programmed logic device, a memory device containing instructions, and so on. Logic may include a gate(s), a combination of gates, other circuit components, and so on.

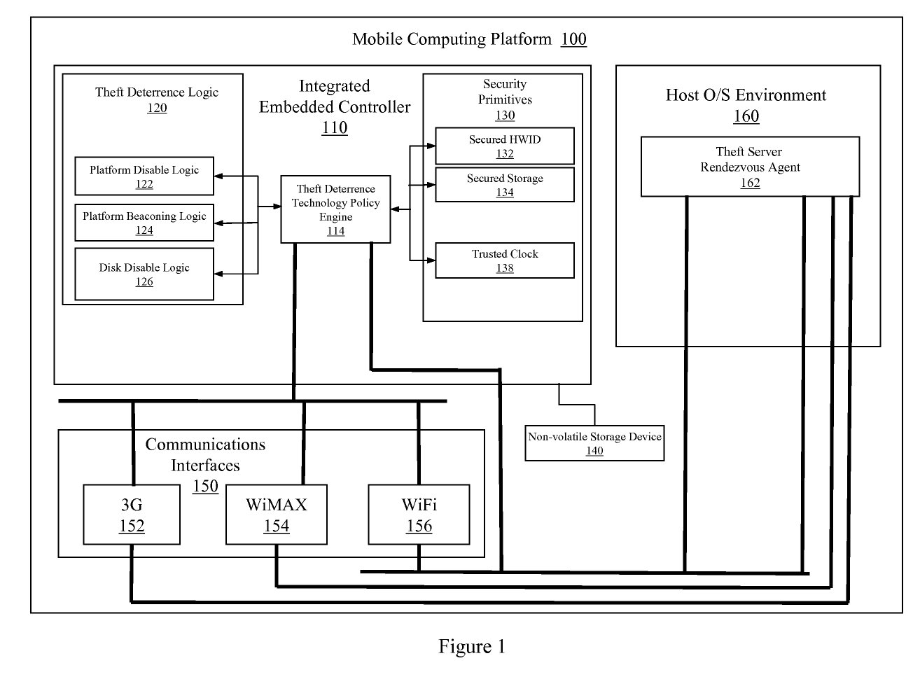

FIG. 1 illustrates a mobile computing platform (MCP) 100. MCP 100 for one embodiment may include an integrated embedded controller (IEC) 110. IEC 110 for one embodiment may facilitate controlling MCP 100 to operate in a normal state or disabled state depending on a possession status (e.g., stolen/not stolen). MCP 100 may be part of a system for protecting MCP 100. The protection may include receiving an asynchronous notification concerning a possession status of MCP 100. Therefore, MCP 100 includes a communications interface to receive an asynchronous notification from a server. FIG. 1 illustrates an example set of communications interfaces 150. The asynchronous notification may be, for example, a safe notification, a lost notification, or a stolen notification.

MCP 100 for one embodiment may include a theft deterrence logic 120 to perform an action in response to receiving an asynchronous notification. Which action is performed, and how that action is performed may be controlled, at least in part, by a theft policy associated with a TDT policy engine 114. The theft policy may describe, for example, which action to take, how long to wait before performing the action, and so on.

Conventional systems may be vulnerable to clever thieves who are able to replace an operating system and/or disk drive in a stolen device. Therefore, for one embodiment of MCP 100, at least a portion of theft deterrence logic 120 is located in IEC 110 which may be located as a member of a chipset for MCP 100. To further thwart clever thieves, MCP 100 for one embodiment may include one or more security primitives 130 located in IEC 110. Security primitives 130 may provide security related primitives including, for example and without limitation, a secured hardware identifier 132, a secured storage 134, and/or a trusted clock 138. Secured hardware identifier 132 for one embodiment may be used to identify MCP 100 to a server. Secured storage 134 may store one or more values, such as one or more encryption keys for example, for MCP 100.

For one embodiment, the action performed by theft deterrence logic 120 may include manipulating one or more encryption keys stored in secured storage 134 of the mobile computing platform. Theft deterrence logic 120 for one embodiment may hide, delete, or otherwise make unavailable one or more encryption keys, for example, to protect encrypted data and communications for MCP 100.

Theft deterrence logic 120 for one embodiment may include a platform disable logic 122. Platform disable logic 122 for one embodiment may selectively disable MCP 100 upon receiving an asynchronous notification as controlled by the theft policy.

Theft deterrence logic 120 for one embodiment may include a platform location beaconing logic 124 to provide information concerning the location of MCP 100 to a server. This location information may be used for one embodiment to select a communications interface and/or a server for potential receipt of an asynchronous notification.

Theft deterrence logic 120 for one embodiment may include a disk disable logic 126 to selectively disable access to a disk drive controlled by MCP 100 upon receiving an asynchronous notification as controlled by the theft policy. Such a disk drive for one embodiment may be encrypted.

For one embodiment, a non-volatile storage device 140 may be coupled to IEC 110 to retain a state of at least a portion of IEC 110 for MCP 100 in the event power is removed from IEC 110. The non-volatile storage device 140 for one embodiment may include, for example and without limitation, any suitable non-volatile random access memory (NVRAM) such as any suitable flash memory for example.

MCP 100 for one embodiment may include communications interfaces 150 to facilitate communications between MCP 100 and a server. Communications interfaces 150 for one embodiment may include a 3G interface 152, a WiMax interface 154, a WiFi interface 156, and/or one or more other suitable communication interfaces. Communications interfaces 150 may use different paths to communicate with a server. MCP 100 may receive an asynchronous notification concerning a possession status (e.g., safe, lost, stolen) of MCP 100 using communications interfaces 150. An asynchronous notification may be provided to TDT Policy engine 114 which may then control other elements, such as theft deterrence logic 120 for example, to take action based at least in part on a possession status from the asynchronous notification.

IEC 110 for one embodiment may provide confirmation, such as a return confirmation message for example, to a server to indicate receipt of an asynchronous notification.

MCP 100 for one embodiment may include a host operating system environment 160. Host operating system environment 160 for one embodiment may also use communications interfaces 150. Host operating system environment 160 for one embodiment may include a theft server rendezvous agent 162 to coordinate communications with a server. Host operating system environment 160 and IEC 110 may operate independently of one another.

MCP 100 may be, for example and without limitation, a notebook or laptop computer, a personal digital assistant (PDA), a cellular telephone, a satellite telephone, a smart phone, a personal email device, a personal media player, a mobile internet device (MID), or any other suitable mobile computing device.

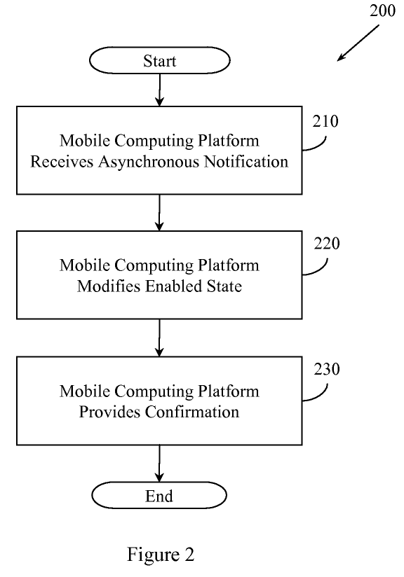

FIG. 2 illustrates a method 200 for a MCP to modify its enabled state. The MCP may receive a push notification of a possession status (e.g., safe, lost, stolen) from a server at block 210. The push notification may be received at a time other than that set by a security timer. Thus, the push notification may be considered to be an asynchronous notification.

At block 220, the MCP may modify an enabled state of MCP. For one embodiment, the MCP may disable and/or destroy encrypted data at block 220 upon receiving the push notification. The MCP for one embodiment may manipulate storage of one or more encryption keys. One skilled in the art will appreciate that the MCP may take other action upon receiving the asynchronous notification of possession status. Modifying the state may include, for example and without limitation, changing a status from safe to presumed lost, changing a status from presumed lost to lost, changing a status from safe to stolen, and changing a status back to safe. The push notification may be sent and received through multiple communication paths that may include, for example, 3G, WiFi, and/or WiMax.

At block 230, the MCP may provide confirmation. The MCP may send a confirmation message to the server that transmitted the asynchronous notification. The confirmation message may be sent, for example, once the notification is received and/or once an action (e.g., disable) taken in response to the notification has been completed. The confirmation message for one embodiment may help facilitate taking action at the server based on acknowledgement that the asynchronous notification was received. For example, the server may note that the notification was received and provide a confirmation to a user that their MCP has been disabled and/or may cease broadcasting the asynchronous notification to the MCP.

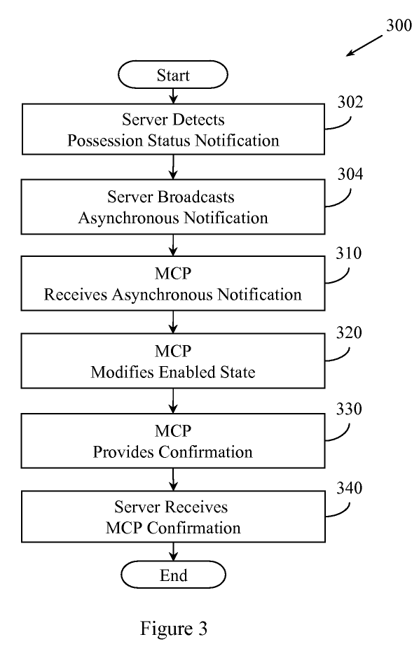

FIG. 3 illustrates a method 300 associated with protecting a MCP using an asynchronous notification. Method 300 includes some actions similar to those described in connection with method 200 of FIG. 2. For example, method 300 includes an MCP receiving an asynchronous notification at block 310, an MCP manipulating an enabled status at block 320, and an MCP providing confirmation at block 330.

Method 300 also includes, at block 302, a server detecting a possession status notification. This may include, for example, receiving a phone call from an owner, receiving an email from a user, receiving a message across a computer network from a user, and so on. Method 300 also includes, at block 304, the server broadcasting the asynchronous notification to the MCP. This is the notification that will be received at block 310. Method 300 also includes the server receiving the confirmation message from the MCP at block 340.

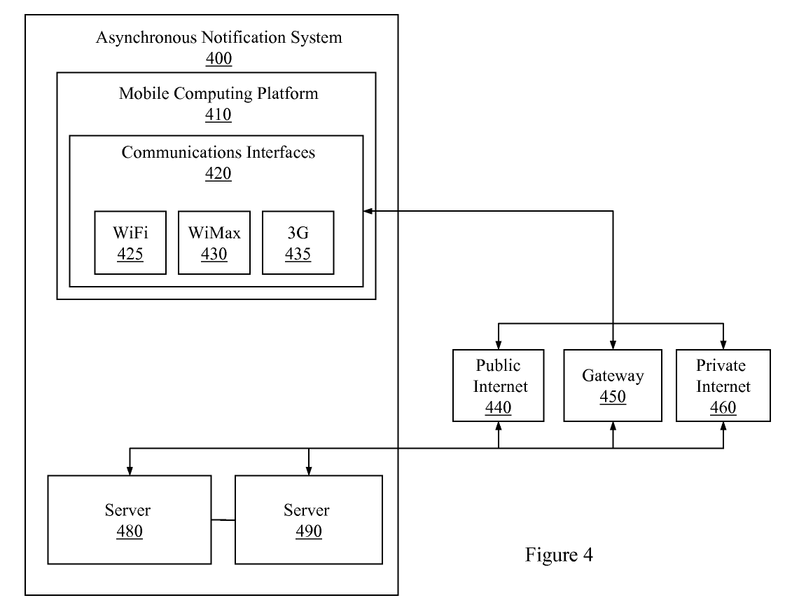

FIG. 4 illustrates an asynchronous notification system 400. System 400 may include a MCP 410. While a single MCP 410 is illustrated, system 400 for one embodiment may include a greater number of MCPs that may be protected using asynchronous push notifications. MCP 410 for one embodiment may contain several different communications interfaces 420. Communications interfaces 420 for one embodiment may include a WiFi interface 425, a WiMax interface 430, a 3G interface 435, and/or one or more other suitable communication interfaces. Communications interfaces 420 may provide multiple paths for MCP 410 to communicate with multiple servers, such as server 480 and/or server 490 for example.

System 400 may communicate over multiple communication paths including, for example and without limitation, the public internet 440, a gateway 450, a private internet 460, and/or one or more other suitable communication paths. Multiple communication paths may be utilized individually or in combination, for example based on path availability. For example, MCP 410 may send data to server 480 and/or server 490 through the public internet 440. Server 480 and/or server 490 may respond to MCP 410 through gateway 450, through private internet 460, and/or through one or more other suitable channels, such as a satellite pathway for example.

System 400 for one embodiment may also use several communication paths to broadcast a disable request to the MCP 410. While a disable request is described, it is to be appreciated that more generally a possession status notification may be pushed to a MCP. A safe notification may be sent when, for example, an owner initially reports that their MCP is lost but then subsequently reports that they located their MCP. Since the MCP may take different actions based on different policies stored in an integrated embedded controller, having the ability to asynchronously push a safe notification to the MCP provides additional flexibility in lost/stolen processing. Server 480 and/or 490 may broadcast the disable request through the last known communication path. In the event a reply is not received in a policy based time period, server 480 and/or 490 may broadcast the message through multiple paths.

Note that communications between the MCP through the IEC and a server may be operating system independent. The IEC may be part of a comprehensive set of tools that facilitate both in-band and out-of-band communication and management. In some embodiments, the IEC may be part of an active management logic that facilitates discovering, healing, and protecting computing assets independent of an operating system. Thus, the IEC may be viewed as a separate system that operates independent of the operating system. Thus, MCP 410 may not be susceptible to defeat of its anti-theft technology by operating system and/or hard drive replacement. The IEC, as part of the chipset of MCP 410 is unlikely to be replaced by a thief and thus should be available to receive a signal from a server.

In the foregoing description, example embodiments have been described. Various modifications and changes may be made to such embodiments without departing from the scope of the appended claims. The description and drawings are, accordingly, to be regarded in an illustrative rather than a restrictive sense.

What is claimed is:

1. An apparatus comprising:
a controller including:
a theft deterrence logic to perform, in response to receiving an asynchronous notification from a server, an action in accordance with a theft policy, and
a secured storage to store one or more values for a mobile computing platform having the controller,
the theft deterrence logic to selectively modify an enabled state of the mobile computing platform in response to the asynchronous notification.

2. The apparatus of claim 1, wherein the asynchronous notification concerns a current possession status of the mobile computing platform.

3. The apparatus of claim 2, wherein the possession status for the asynchronous notification includes stolen or lost.

4. The apparatus of claim 2, wherein the possession status for the asynchronous notification includes safe.

5. The apparatus of claim 1, wherein the theft deterrence logic is to manipulate one or more encryption keys stored in the secured storage in response to the asynchronous notification.

6. The apparatus of claim 1, wherein the controller is an integrated embedded controller and a member of a chipset for the mobile computing platform.

7. The apparatus of claim 1, wherein the theft deterrence logic includes a platform disable logic to selectively disable the mobile computing platform in response to the asynchronous notification and in accordance with the theft policy.

8. The apparatus of claim 1, wherein the theft deterrence logic includes a platform beaconing logic to provide information concerning a location of the mobile computing platform to the server.

9. The apparatus of claim 1, wherein the theft deterrence logic includes a disk disable logic to selectively disable a disk drive of the mobile computing platform in response to the asynchronous notification and in accordance with the theft policy.

10. The apparatus of claim 1, comprising a non-volatile storage device to retain a state of at least a portion of the controller.

11. The apparatus of claim 1, wherein the controller is to provide a confirmation of receipt of the asynchronous notification to the server.

12. The apparatus of claim 1, comprising multiple communications interfaces to receive the asynchronous notification over one of multiple communications paths.

13. A method comprising:
receiving from a server an asynchronous notification concerning a current possession status of a mobile computing platform;
selectively modifying an enabled state of the mobile computing platform in response to the asynchronous notification,
wherein the selectively modifying includes manipulating one or more encryption keys stored in a secured storage of the mobile computing platform.

14. The method of claim 13, wherein the possession status for the asynchronous notification includes stolen or lost.

15. The method of claim 13, wherein the possession status for the asynchronous notification includes safe.

16. The method of claim 13, comprising providing information concerning a location of the mobile computing platform to the server.

17. The method of claim 13, wherein the selectively modifying includes selectively disabling a disk drive of the mobile computing platform in response to the asynchronous notification.
